(19) United States
(12) Patent Application Publication
(10) Pub. No.: US 2024/0387124 A1
(43) Pub. Date: Nov. 21, 2024

(54) CONTACT DISK FOR A VACUUM SWITCH, VACUUM SWITCH AND PRODUCTION METHOD FOR A CONTACT DISK

(71) Applicant: Siemens Aktiengesellschaft, München (DE)

(72) Inventors: Frank Graskowski, Wandlitz (DE); Hermann Bödinger, München (DE); Carsten Schuh, Baldham (DE); Thomas Brauner, Berlin (DE); Kira Berdien Wüstenberg, Berlin (DE)

(21) Appl. No.: 18/691,530

(22) PCT Filed: Sep. 15, 2022
(86) PCT No.: PCT/EP2022/075616

§ 371 Date: Mar. 13, 2024

(30) Foreign Application Priority Data
Sep. 23, 2021 (DE) 10 2021 210 643.9

(51) Int. Cl. H01H 33/664; H01H 11/04

(52) U.S. Cl. CPC H01H 33/6643; H01H 11/04

(57) ABSTRACT

A contact disc of a contact element for a vacuum switch is provided, which includes predominantly of a first conductive material or composite material and has a plurality of inlets distributed over the circumference and made of a second material with a lower level of conductivity relative to the first material or composite material, which, during a switching process of the vacuum switch, bring about the formation of a magnetic field and thereby a movement of an arising arc on a predefined path and/or an extensive propagation of the arc. A production method for a contact disc of this type is also provided.

### CROSS-REFERENCE TO RELATED APPLICATIONS

This application claims priority to PCT Application No. PCT/EP2022/075616, having a filing date of Sep. 15, 2022, which claims priority to DE Application No. 10 2021 210 643.9, having a filing date of Sep. 23, 2021, the entire contents both of which are hereby incorporated by reference.

### FIELD OF TECHNOLOGY

The following relates to a novel contact disk for vacuum switches, to a vacuum switch having such a contact disk, and to a production method for a contact disk.

### BACKGROUND

In vacuum switches or vacuum interrupters for the low-, medium- and high-voltage range, what are referred to as radial or axial magnetic field contacts (RMF and AMF contacts, respectively) are used in particular for switching off currents greater than a few kiloamperes. The structure, function and operating principles of such contact elements with a conventional design are described comprehensively, for example, in the dissertation published in 2003 “Modellierung des Plasmas im Vakuum-Leistungsschalter unter Berücksichtigung axialer Magnetfelder” [Modeling the plasma in a vacuum circuit breaker in consideration of axial magnetic fields], by K. Jenkes-Botterweck, available online at http://publications.rwth-aachen.de/record/58842.

Commonplace designs are the spiral contact and the pot contact. In the case of the spiral contact, disclosed for example in DE102019216869A1 and DE102017214805A1, the required magnetic field is generated by the geometric configuration of the contact disk itself: in the case of other contact shapes, in particular in the case of the pot contact, which is likewise known for example from DE102017214805A1, the magnetic field is formed by an additional coil body, on which the contact disk is placed.

A variant of a contact in which the magnetic field is formed by a coil body is known from DE 33 02 595 A1. A body which is helically wound, or provided with helical recesses, and made of a first material of lower electrical conductivity is potted with a second material of higher conductivity with a lower melting and casting temperature, wherein in particular the spaces between the helical windings or the recesses are potted. Here, the body manufactured from the first material is a part of the casting mold for the second material. An unstructured contact disk made of especially lightweight sheet material is then soldered onto the contact-making end face of the contact carrier produced in this way.

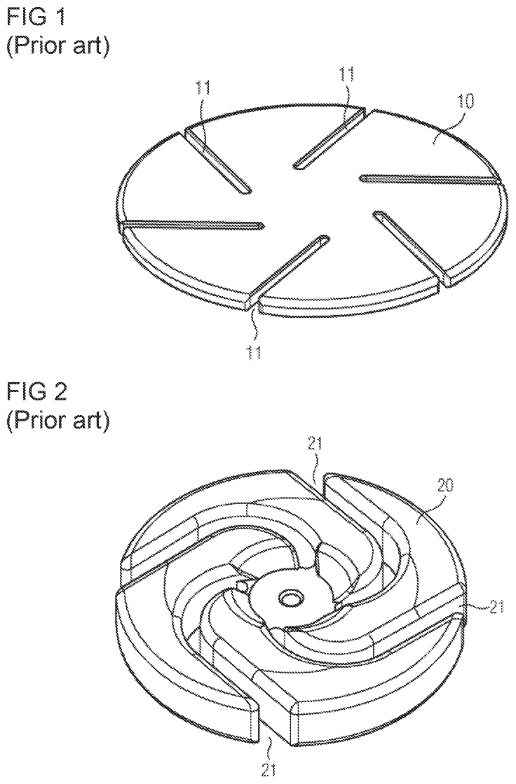

FIG. 1 shows a schematic illustration of a conventional AMF contact disk 10. The contact disk 10 has a plurality of oblique slots 11, which are distributed over the circumference and are shaped such that, upon a flow of current, they (together with the geometry of the corresponding mating contact) bring about the formation of a magnetic field, which brings about a movement of a resulting arc on a predefined path and/or a large-area propagation of the arc.

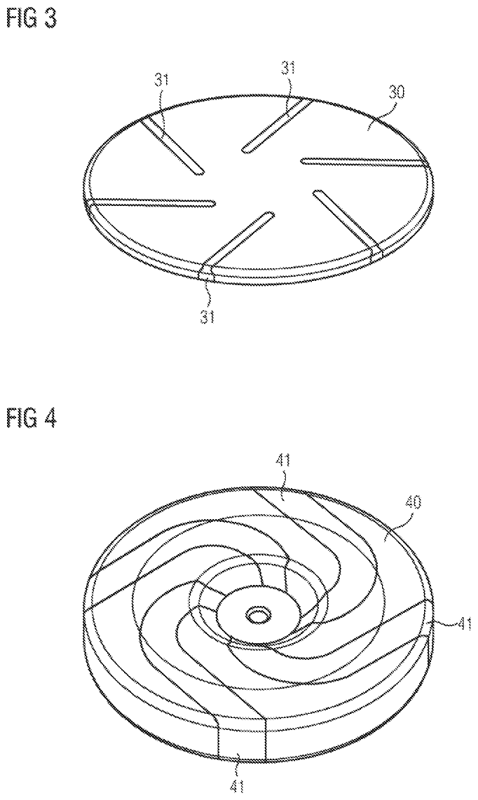

FIG. 2 shows a conventional spiral contact disk 20, which has a plurality of helical slots 21, which are distributed over the circumference and are likewise made in the contact disk 20 such that, upon a flow of current, they (together with the geometry of the corresponding mating contact) bring about the formation of a magnetic field, which brings about a movement of a resulting arc on a predefined path and/or a large-area propagation of the arc.

FIGS. 1 and 2 do not illustrate the respective contact carrier or coil body.

A disadvantage of the contact disks according to the conventional art is that the slotting of the contact disk has a considerable adverse effect on its mechanical stability. In addition, the machining processes used to make the slots leave behind sharp edges and burrs, which must be rounded off or removed in additional work steps in order to prevent injuries when the contact disks and the finished contact elements are being handled. Sharp edges and burrs can also lead to local increases in the electrical field strength and thus impair the dielectric strength of the vacuum interrupter. Burrs can also become detached under the influence of the electrical field and/or owing to mechanical vibrations during the switching operations and introduce an electrical discharge in the vacuum interrupter.

Arc events on the surface of a contact disk also cause partial melting, in particular along the slot edges, as a result of which the slots can become narrower and ultimately completely short-circuited as the number of switching operations increases.

### SUMMARY

An aspect relates to a contact disk for vacuum switches and a production method for such a contact disk, as a result of which the described disadvantages are avoided.

This aspect is achieved according to embodiments of the invention by a contact disk of a contact element for a vacuum switch, which contact disk includes predominantly of a first conductive material or composite substance and has a plurality of embeddings of a second material of lower conductivity than the first material or composite substance, which are distributed over the circumference and bring about the formation of a magnetic field and thus a movement of a resulting arc on a predefined path and/or a large-area propagation of the arc in the event of a switching operation of the vacuum switch.

In other words, according to embodiments of the present invention, a material which has a lower conductivity than the material of the contact disk is embedded in the slot-shaped openings known from the conventional art, wherein the shape of the embeddings is not restricted to slots but rather allows a considerably wider variety of shapes, as a result of which in turn it becomes possible to optimize the magnetic field formation, this not being implementable, or being implementable only with very high outlay, with the conventional cutting or machining processes.

Embodiments of the present invention also avoid or reduce the effect arising in the conventional art that the slots can become narrower and ultimately completely short-circuited as the number of switching operations increases, since the slots are already filled with material and thus the deposition of material is at least made more difficult.

“Embedding” in this respect means that the second material is introduced into the first material already during the molding of the basic shape of the contact disk and not subsequently, that is to say for example not by making slots in a contact disk that are then filled with the second material.

In embodiments of the invention, the first conductive material, that is to say the material of the main body of the contact disk, is copper or a copper-based composite substance, in particular CuCr25 or CuCr30 or CuCr35.

For the material embedded in the slots, use is made of stainless steel or another metal with considerably lower conductivity than copper. The conductivity of the second material is less than one tenth the conductivity of the first material. In alternative embodiments, ceramics, ceramic-metal composite substances (cermets) or plastics are utilized as second material.

A contact disk according to embodiments of the invention can, for example, be produced by additive production methods (3D printing), in particular by a 2-component 3D printing method. The advantage of 3D printing is that the contact disk including the embeddings can be manufactured in one process step and also complex slot shapes can be realized, which cannot be realized, or can be realized only with high outlay, with conventional machining processes.

Embodiments of the present invention also relate to a vacuum switch having a vacuum chamber, inside which two contact elements are arranged, wherein at least one of the contact elements comprises a contact disk according to embodiments of the invention.

Embodiments of the present invention moreover relate to an alternative method to 3D printing for producing a contact disk according to embodiments of the invention, which consists/comprises predominantly of a first material or composite substance. In embodiments of the method, one or more moldings made of a second material with lower conductivity than the first material or composite substance are introduced into a powder bed or a pressing die. Then, if required, moldings determining the shape of the contact disk are introduced into the pressing die. A powder of the first material or a powder mixture or else green parts prepressed from powder is/are introduced into the pressing die. Then, a pressing force is exerted such that the contact disk with the incorporated or embedded moldings is produced from the powder or the powder mixture. As an alternative, it is also possible for moldings made of the first material to form the starting point, and a powder or pre-pressed green body made of the second material is introduced.

An electrical current is additionally applied to the powder or the powder mixture during the pressing operation.

The voltage feed-in points and the respective fed-in electrical powers are selected such that the currents flowing through the one or more powders are approximately evenly distributed.

The (first) powder used is a copper powder or a mixture of copper particles and a further conductive material, such as chromium. Stainless steel is selected as the second material.

The one or more moldings are configured such that, after compression and sintering of the one or more powders, they form embeddings in the contact disk that are distributed over the circumference and bring about the formation of a magnetic field and thus a movement of a resulting arc on a predefined path and/or a large-area propagation of the arc in the event of a switching operation of the vacuum switch.

Exemplary embodiments of the present invention are explained in more detail below with reference to drawings. It should be noted that all of the variants, embodiments and exemplary embodiments disclosed above and below can be combined with one another without restrictions.

### BRIEF DESCRIPTION

Some of the embodiments will be described in detail, with references to the following Figures, wherein like designations denote like members, wherein:

FIG. 1 shows a schematic illustration of a conventional AMF contact disk;

FIG. 2 shows a conventional spiral contact disk:

FIG. 3 schematically shows a perspective illustration of an AMF contact disk according to a first exemplary embodiment of the present invention:

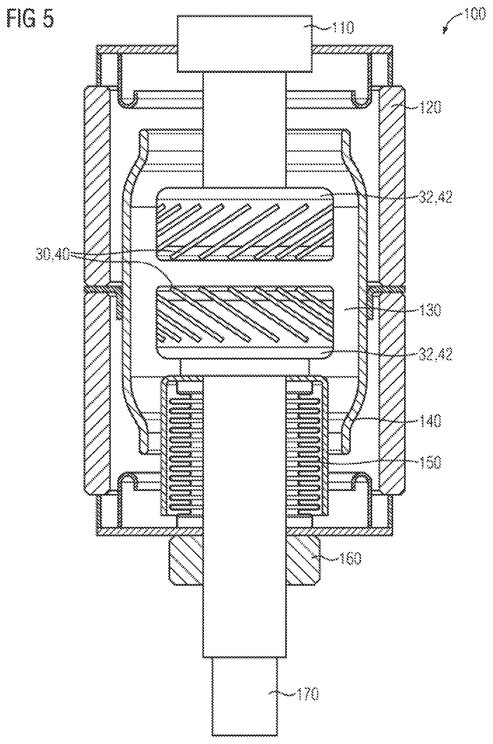

FIG. 4 schematically shows a perspective illustration of a spiral contact disk according to a second exemplary embodiment of the present invention; and

FIG. 5 schematically shows a partial sectional illustration of a vacuum switch according to one exemplary embodiment of the present invention.

### DETAILED DESCRIPTION

FIGS. 1 and 2 do not illustrate the respective contact carrier or coil body.

FIG. 3 shows an AMF contact disk 30 of an AMF contact element for a vacuum switch 100 consisting of/comprising a first conductive material or composite substance. In embodiments, the first conductive material may be copper. For the sake of clearer illustration of embodiments of the present invention, the contact carrier has not been illustrated.

However, it should be noted that the contact disk 30 or a contact-disk region may be mounted on the surface of a contact carrier or, in refinements of embodiments of the present invention, be formed in one piece with the contact carrier, specifically on that surface of the contact element that is later to form the disconnectable electrical connection of the vacuum switch.

The contact disk 30 comprises a plurality of oblique embeddings 31, which are distributed over the circumference, are substantially slot-shaped in the example of FIG. 3, and in which a second material of lower electrical conductivity than the first material is embedded, specifically such that, upon a flow of current, the embeddings (together with the geometry of the embeddings or slots of the corresponding mating contact) bring about the formation of a magnetic field and thus a movement of a resulting arc on a predefined path and/or a large-area propagation of the arc.

FIG. 4 shows a spiral contact disk 40 of a contact element for a vacuum switch 100, likewise consisting of/comprising a first conductive material or composite substance. In embodiments, the first conductive material may be copper. The contact carrier has also not been illustrated in FIG. 4 for the sake of clearer illustration of embodiments of the present invention. It also holds true for the spiral contact disk 40 that the contact disk 40 or a contact-disk region may be mounted on the surface of a contact carrier or, in refinements of embodiments of the present invention, be formed in one piece with the contact carrier, specifically on that surface of the contact element that is later to form the disconnectable electrical connection of the vacuum switch.

The contact disk 40 comprises a plurality of embeddings 41, which are distributed over the circumference and extend helically, thus increasing the length of the embedding in comparison with straight slots as in FIG. 3. A second material of lower electrical conductivity than the first material is embedded in these embeddings, specifically again such that, upon a flow of current, the embeddings (together with the geometry of the embeddings or slots of the corresponding mating contact) bring about the formation of a magnetic field and thus a movement of a resulting arc on a predefined path and/or a large-area propagation of the arc.

FIG. 5 shows a vacuum interrupter 100 having two contacts with contact carriers 32, 42, to which contact disks 30, 40 according to embodiments of the present invention have been applied. This figure, purely by way of example, illustrates two AMF contacts with contact disks 30 according to FIG. 3 in detail. Other exemplary embodiments make use of other contact-disk shapes designed in accordance with the present invention.

The vacuum switch 100 has a stationary connecting disk or a stationary connecting bolt 110 made of conductive material, for example, copper. It is connected to the coil body 32, 42 of a stationary contact. A movable contact is oriented plane-parallel to the stationary contact and is carried by a movable connecting bolt 170. Axially moving the movable connecting bolt 170 in the direction of the stationary connecting bolt 110 closes the vacuum switch and moving it in the opposite direction opens the vacuum switch. The movable connecting bolt is guided in a guide 160.

The two contacts are arranged in a vacuum chamber 130, which is lined with a shield 140 and includes of a body 120 made of insulating material. A metal bellows 150 serves to seal off the vacuum chamber 130 with respect to the surrounding area in the region of the lead through of the movable connecting bolt into the vacuum chamber.

A desired production method for producing the contact disks 30, 40 is described below.

One or more moldings, made of stainless steel, which later form the embeddings in the contact disk 40, are introduced into a die. The position of the moldings is defined by suitable means. For example, use can be made of a molding in which the multiple embeddings are connected to one another by narrow connecting pieces, which do not impair the later function, and thus form a molding composite, which keeps its shape relative to the following powder filling.

As an alternative, multiple moldings, which largely correspond to their final shape but project somewhat beyond the later circumference of the contact element, can be inserted into corresponding receptacles in the die. The material of the moldings that projects beyond the circumference can then be conjointly removed in the course of the final surface processing of the contact element.

Copper powder, or a powder mixture of copper and chromium, is filled into the interspaces of the die so as to surround the moldings and a uniaxially acting pressure is applied to it via the pressing punch. Electrical current is at the same time made to flow through the sample to be sintered in the manner of a series circuit via the pressing punch and the die. The Joule heating thus generated of the sample, or the die has the effect that the sample heats up very quickly, and thus makes it possible to efficiently sinter the substance.

As already mentioned, it is also possible for moldings made of the first material to form the starting point, and a powder or pre-pressed green body made of the second material is introduced.

The die may additionally have moldings influencing the shape of the contact disk.

In exemplary embodiments of the present invention, the whole contact element, including the contact disk and the contact carrier, can be produced by the sintering method.

At the end of the SPS method, what is provided is a contact disk of which the surfaces still need to be processed, for example by polishing, depending on the quality to be achieved, for example in order to obtain a contact surface which is as planar and groove-free as possible. By contrast to known methods, however, the contact disk is not slotted, and the slots are not deburred. Moreover, by contrast to slotting methods, it is possible to configure the moldings virtually as desired and thus optimize the magnetic field.

It is advantageous that the sintered contact disk or the sintered contact element has a very near net shape, i.e. only a little waste material is incurred during the final processing.

As already indicated, in advantageous refinements of embodiments of the present invention it is possible to manufacture the contact disk from a composite material by adding, instead of pure copper powder, a suitable powder mixture that consists of copper and a further material and in the sintered state exceeds the strength and/or the resistance to arc erosion of copper. This can also be effected to a limited extent locally, i.e., for example in regions of the coil body that are exposed to particular mechanical and/or electrical loading, such as the surface of the contact disk.

It should be noted that only selected exemplary embodiments that utilize the present invention have been described here. In particular, it is possible, for example, to design and manufacture other shapes of contact disks and contacts using the principles described here. Similarly, the materials designated as desired are indeed desired, but embodiments of the invention are not restricted to these materials. As already mentioned, it is also for example possible to select, instead of the sintering method, an additive production method (3D printing), for which most of the statements and advantages disclosed in connection with the sintering method apply, mutatis mutandis.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A contact disk of a contact element for a vacuum switch, comprising predominantly of a first conductive material or a composite substance,
wherein
the contact disk comprises a plurality of embeddings of a second material of lower conductivity than the first material or composite substance, which are distributed over the circumference and bring about the formation of a magnetic field and thus a movement of a resulting arc on a predefined path and/or a large-area propagation of the arc in the event of a switching operation of the vacuum switch.

2. The contact disk as claimed in claim 1, in which the first conductive material is copper or in which the composite material comprises copper and chromium.

3. The contact disk as claimed in claim 1, in which the second material is stainless steel.

4. A vacuum switch having a vacuum chamber, inside which two contact elements are arranged, wherein at least one of the contact elements comprises a contact disk as claimed in claim 1.

5. A method for producing a contact disk, comprising predominantly of a first conductive material or composite substance, of a contact element for a vacuum switch, having the following steps:
introducing one or more moldings made of a second material with lower conductivity than the first material or composite substance into a powder bed or a pressing die:
introducing a powder of the first material or a powder mixture comprising the first material or one or more pre-pressed green bodies comprising the first material into the powder bed or the pressing die; and
exerting pressing force such that the powder or the powder mixture or the one or more green bodies is/are sintered with the moldings to form the contact disk.

6. The method as claimed in claim 5, in which the powder is a copper powder or a mixture of copper particles and a further conductive material, in particular chromium, or the one or more green bodies consists/consist of copper or a mixture of copper particles and a further conductive material.

7. The method as claimed in claim 5, in which the second material is stainless steel.

8. A method for producing a contact disk, comprising predominantly of a first conductive material or composite substance, of a contact element for a vacuum switch, having the following steps:
introducing one or more moldings made of the first material or composite substance of lower conductivity into a powder bed or a pressing die:
introducing a powder of a second material with lower conductivity than the first material or composite substance or a powder mixture or one or more pre-pressed green bodies comprising such a second material into the powder bed or the pressing die; and
exerting pressing force such that the moldings and the powder or the powder mixture or the one or more green bodies are sintered to form the contact disk.

9. The method as claimed in claim 8, in which the moldings are made of copper or a composite substance comprise copper and a further conductive material.

10. The method as claimed in claim 8, in which the second material is stainless steel.

11. The method as claimed in claim 5, in which an electrical current is additionally applied to the powder during the pressing operation.

12. The method as claimed in claim 11, in which voltage feed-in points and the respective fed-in electrical powers are selected such that the currents flowing through the powder or the powder mixture or the one or more green bodies are approximately evenly distributed.

13. The method as claimed in claim 5, in which the one or more moldings are configured such that, after compression and sintering of the powder, embeddings of the second material are formed in the contact disk, which are distributed over the circumference and bring about the formation of a magnetic field and thus a movement of a resulting arc on a predefined path and/or a large-area propagation of the arc in the event of a switching operation of the vacuum switch.

14. The method as claimed in claim 9, wherein the further conductive material is chromium.

15. The contact disk of the contact element for the vacuum switch of claim 1, comprising predominantly of the first conductive material or the composite substance.

16. The method for producing the contact disk of claim 5, comprising predominantly of the first conductive material or the composite substance.

17. The method for producing a contact disk of claim 8, comprising predominantly of the first conductive material or the composite substance.
